(19) United States
(12) Patent Application Publication
(10) Pub. No.: US 2021/0179304 A1
(43) Pub. Date: Jun. 17, 2021

(54) AUTOMATED PACKAGING APPARATUS FOR A FOOD ITEM AND CORRESPONDING METHOD

(71) Applicant: ACTIVE8 ROBOTS LIMITED, Chilcompton Radstock Somerset (GB)

(72) Inventors: Antony Lovedale, Chilcompton (GB); Alan Quinn, Middlezoy (GB); Jason Clark, Midsomer Norton (GB); Victor Kozlovs, Hardwicke (GB)

(73) Assignee: ACTIVE8 ROBOTS LIMITED, Chilcompton Radstock Somerset (GB)

(21) Appl. No.: 17/263,138

(22) PCT Filed: Apr. 2, 2019
(86) PCT No.: PCT/GB2019/050948

§ 371 Date: Jan. 25, 2021

(30) Foreign Application Priority Data
Jul. 27, 2018 (GB) 1812244.0

(51) Int. Cl. B65B 35/16; B65B 25/00; B65B 5/06; B65G 47/86; B65G 47/248; B65B 25/18

(52) U.S. Cl. CPC B65B 35/16; B65B 25/001; B65B 25/18; B65G 47/842; B65G 47/248; B65B 5/06

(57) ABSTRACT

Food manipulation apparatus (10) is provided and comprises manipulation means (20) which moves two parts of a food item (30) between a first relative disposition and a second relative disposition. Furthermore, a robot (70) may be provided to place the food item (30) into a container (85).

The present invention relates generally to a sandwich packaging process and particularly, although not exclusively, to the automation of one or more aspects of a packaging process.

Sandwich packing is often an entirely manual human process in which sandwiches are prepared (e.g. assembled and cut) and placed into a packaging container (such as a skillet).

The present invention seeks to provide improvements in or relating to the packaging of sandwiches.

An aspect of the present invention provides food manipulation apparatus comprising manipulation means which moves two parts of a food item between a first relative disposition and a second relative disposition.

In some embodiments, in the first relative disposition the parts lie generally flat and in a second relative disposition the parts lie generally upright.

Examples of food items that may require the relative movement provided by the present invention include sandwiches, baguettes, omelettes, Cornish pasties and deserts such as apple turnovers. For example the two parts may comprise two sandwich halves.

A further aspect of the present invention provides a sandwich manipulation apparatus comprising manipulation means for moving two sandwich halves from a generally flat, adjacent configuration to an upright, side-by-side configuration.

A sandwich is an item of food comprising two (normally generally flat) pieces of bread with a filling between them.

In aspects and embodiments of the present invention the manipulation means may, for example, comprise a pair of conveyors, such as belts, loops or chains.

In some embodiments the conveyors, such as endless belts, loops or chains, are removable from the apparatus, for example to allow cleaning, replacement or maintenance.

The conveyors may, for example, turn both of the food item parts through an angular disposition in the range 45 degrees to 120 degrees. In some embodiments each of the parts is moved by approximately the same angular amount.

In some embodiments the conveyors turn through approximately 90 degrees from an inlet end to an outlet end. For example in one embodiment at the inlet end the conveyors are generally horizontal and at the outlet end the conveyors are generally vertical, whereby both conveyors twist along their length so as to gradually fold the two food parts together as they pass along therealong.

In some embodiments the conveyors turn sandwich halves through approximately 90 degrees from a sandwich inlet end to a sandwich outlet end. For example in one embodiment at the sandwich inlet end the conveyors are generally horizontal and at the sandwich outlet end the conveyors are generally vertical, whereby both conveyors twist along their length so as to gradually fold the two sandwich halves together as they pass along therealong.

The apparatus may further comprise a presentation conveyor for presenting the parts to the manipulation means. For example the apparatus may further comprise a presentation conveyor for presenting sandwich halves to the manipulation means. Normally the sandwiches will be pre-prepared and pre-cut (for example using ultrasonic cutting).

In some embodiments the food item is a whole sandwich that is generally square and is cut into two generally triangular halves. Other embodiments can have different whole/cut shapes.

The term “halves” may mean two generally similar/identical pieces, but not necessarily.

In some embodiments the manipulation means is adjustable. For example, manipulation conveyors may be width adjustable to accommodate different sizes of food items. In some embodiments the gap between opposed conveyors is adjustable. In some embodiments conveyors move on rollers or the like; either or both of a lead roller and a tail roller may be movable (for example by pivoting, lateral or axial movement) to adjust the distance between the conveyor pair.

The apparatus may further comprise an outlet conveyor for receiving manipulates food item parts from the manipulation means. For example the apparatus may further comprise an outlet conveyor for receiving sandwiches from the manipulation means.

The outlet conveyor may comprise one or more bays for receiving parts in the second relative disposition. For example the conveyor may comprise bays for receiving sandwiches in the upright, side-by-side configuration.

The outlet conveyor may comprise guide means for preventing relative movement of the parts. For example the conveyor may comprise guide means for preventing delamination of sandwich halves as they move through a picking station.

The apparatus may further comprise one or more robot pickers for picking food parts from the outlet conveyor and transferring them to a packaging container. For example the apparatus may further comprise one or more robot pickers for picking sandwiches from the outlet conveyor and transferring them to a packaging container.

The robot may, for example comprise an actuated gripper.

In some embodiments the gripper tool is driven to rotate on one side of the item; in other embodiments both sides of the item are drive to rotate.

The robot may comprise means for rotating the food item with the parts maintained in a side-by-side configuration. For example the robot may comprise means for rotating the sandwich with the halves maintained in a side-by-side configuration. Inversion of the sandwich may be preferred for some containers.

An indexing conveyor for conveying containers (such as pre-assembled cardboard skillets) may be provided next to the outlet conveyor.

In some embodiments the packaging container is a preformed skillet, for example a cardboard skillet.

The present invention also provides a robotic picker for picking a sandwich from a conveyor, the picker comprising an actuated gripper and means for in-line rotating a sandwich whilst gripped and prior to release.

The present invention also provides a method of placing a sandwich into a packaging container, comprising the steps of: providing a pre-prepared sandwich; pre-cutting the sandwich into two halves; orientating sandwich halves from a flat configuration to an upstanding configuration; and placing the juxtaposed sandwich halves into a container.

The present invention also provides a sandwich making process comprising the steps of: preparing a sandwich; cutting the sandwich into two halves; orientating the sandwich halves so that they are in an upstanding, side-by-side configuration; using a robot to pick up the sandwich halves together; and placing the sandwich halves into a container.

In some embodiments the sandwich halves are inverted (rotated end-over-end) prior to placing into the container.

Some aspects and embodiments of the present invention relate to a system, machine or process for orientating and packing sandwiches into skillets, for example a sandwich skilleting machine.

Different aspects of the present invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims.

Referring now to the drawings, wherein like reference numbers are used to designate like elements throughout the various views, several embodiments of the present invention are further described by way of example.

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, radially and axially, are used in relation to the drawings and should not be interpreted as limiting on the invention.

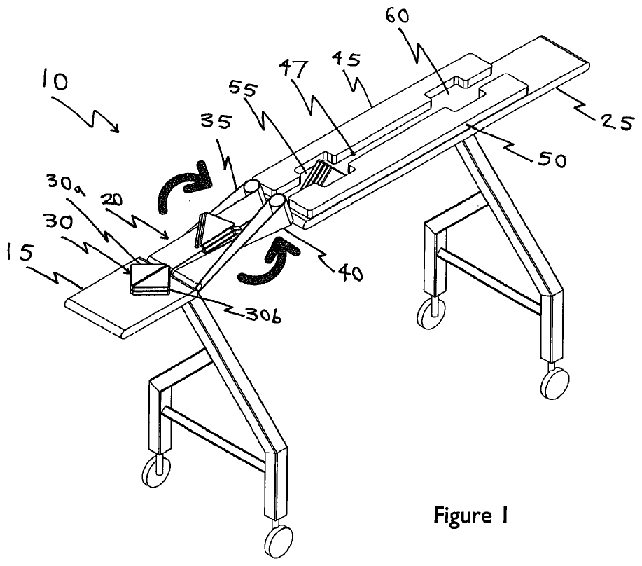

Referring first to FIG. 1 there is shown part of a sandwich assembly machine generally indicated 10.

The machine 10 comprises, in brief, a sandwich presentation conveyor 15, an orientation conveyor 20 and an outfeed conveyor 25.

Incoming sandwiches 30 are prepared and pre-cut into two generally equal triangular halves 30a, 30b before entering the sandwich presentation conveyor 15 in a generally flat, horizontal orientation.

The orientation conveyor 20 (described in more detail below) orientates each sandwich half using 90° twisted conveyors 35, 40.

The orientated sandwich passes onto the outfeed conveyor 25.

Conveyor guides 45, 50 are provided above the conveyor 25 and include, in this embodiment, two robot pick locations 55, 60. The sandwich 30 is guided to the robot pick locations through a centrally running slot 47 to prevent delimitation (i.e. the guides prevent the sandwich halves from falling apart).

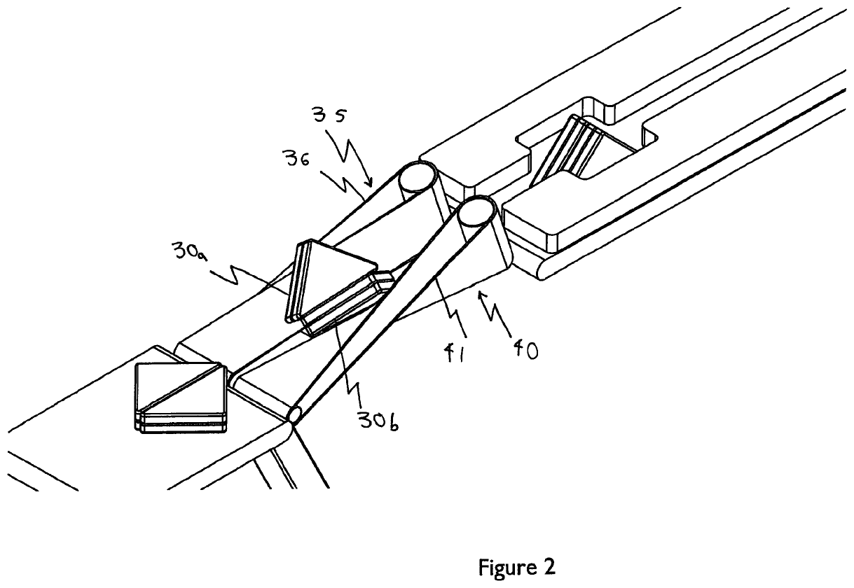

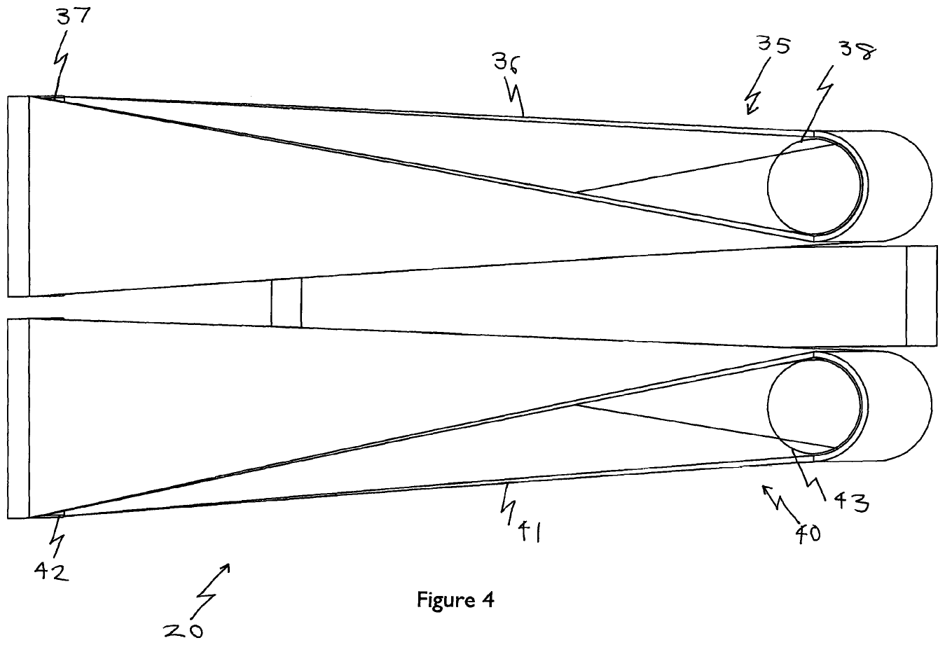

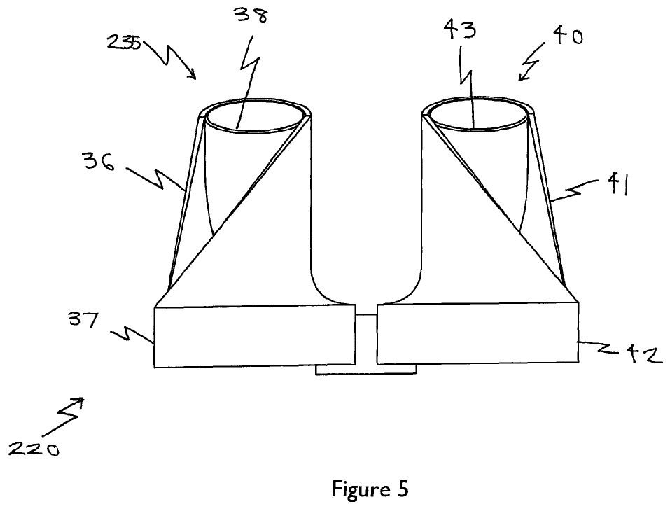

As also shown in FIGS. 2 to 5, the orientation conveyors 35, 40 each comprise an endless belt 36, 41 which is secured at one end (the inlet end) by a horizontal roller 37, 42 and at the other end by a “vertical” roller 38, 43—in this embodiment the roller actually inclined away from the vertical in a plane orthogonal to the line of travel. The vertical and horizontal rollers are oriented at approximately 90 degrees with respect to each other (along the line of sandwich movement). This means that the belts 36, 41 twist along their length.

As illustrated in FIGS. 1 and 2, this means that as sandwich halves 30a, 30b move from the inlet end to the outlet end of the orientation conveyor 20 they are gradually “folded” together by the belts 36, 41 so that they assume an upright, “vertical” configuration.

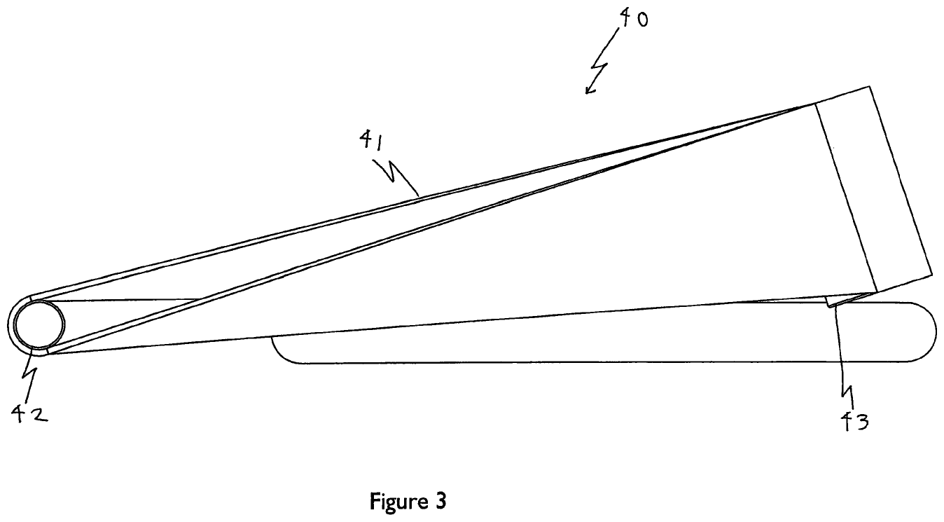

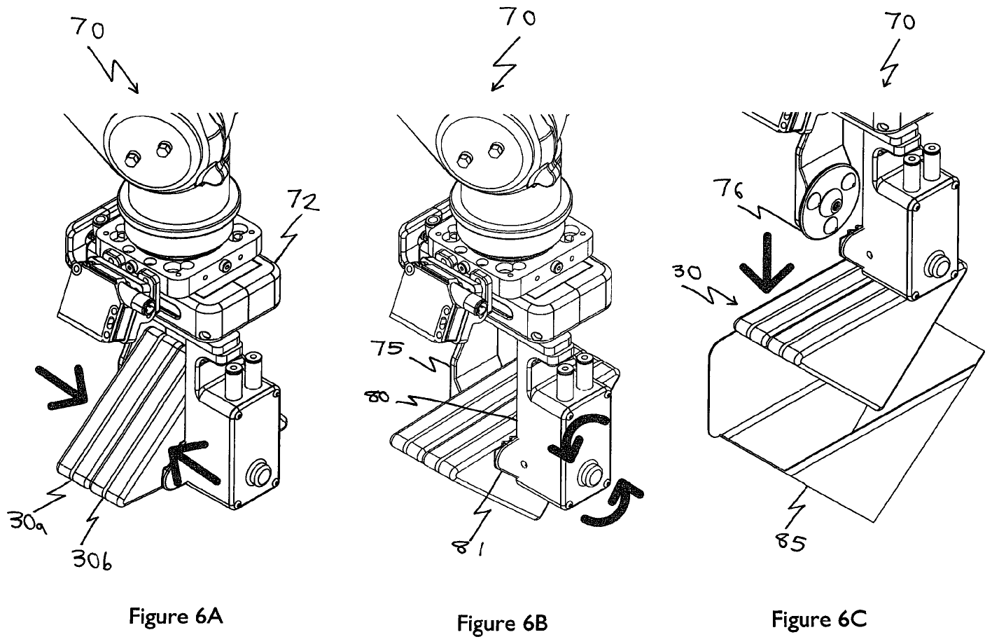

The robot picks the sandwich from a pick location along the presentation conveyor 25 using an actuated gripper tool 72 (FIG. 6A); then the tool rotates the sandwich (FIG. 6B); and then the tool release the sandwich into a pre-assembled skillet (FIG. 3C).

In this embodiment the robot tool 72 comprises a pair of spaced grippers 75, 80. Either or both of the grippers can be moved inwards to grip sandwich halves.

The gripper 75 is provided with a rotatable disc 76 (see FIG. 6C) and the gripper 80 has a rotating plate 81. When the sandwich is gripped the plate 81 is driven to rotate. In this embodiment the disc 76 rotates passively; in other embodiments both grippers have driven rotators.

After the sandwich 30 is inverted/rotated the robot releases it into a pre-assembled skillet 85.

A skillet conveyor (not shown) is provided alongside the sandwich manipulation apparatus. A robot station (not shown) is also provided with one more robot arms.

In this embodiment the process is repeated with two robots until four skillets are completed.

In some embodiments a vision system may be used, for example to check that sandwich halves have been successfully folded together and/or to check that a sandwich has been correctly placed in a skillet. A rejection system may also be provided.

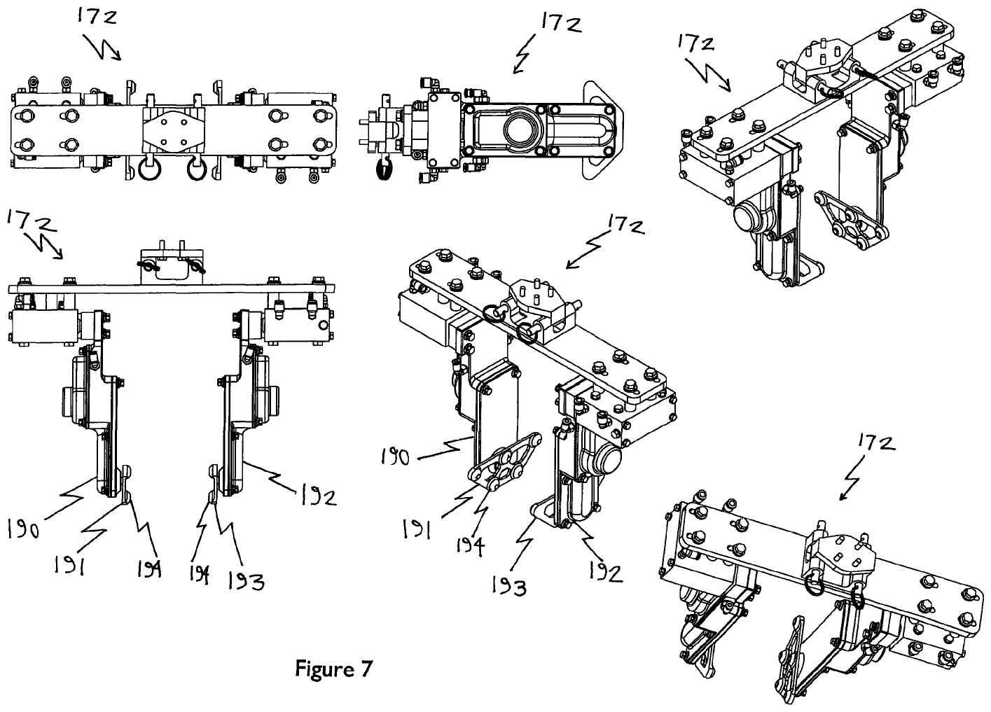

FIG. 7 shows a tool 172 formed according to an alternative embodiment. In this embodiment two spaced arms 190, 192 are provided. Relative separation and approach of the arms is possible.

At the free end of the arms 190, 192 a generally trapezoidal rotating plate 191, 193 is provided. Each of the plates 191, 193 is provided with raised protuberances 194 which in use help to grip the foot item parts.

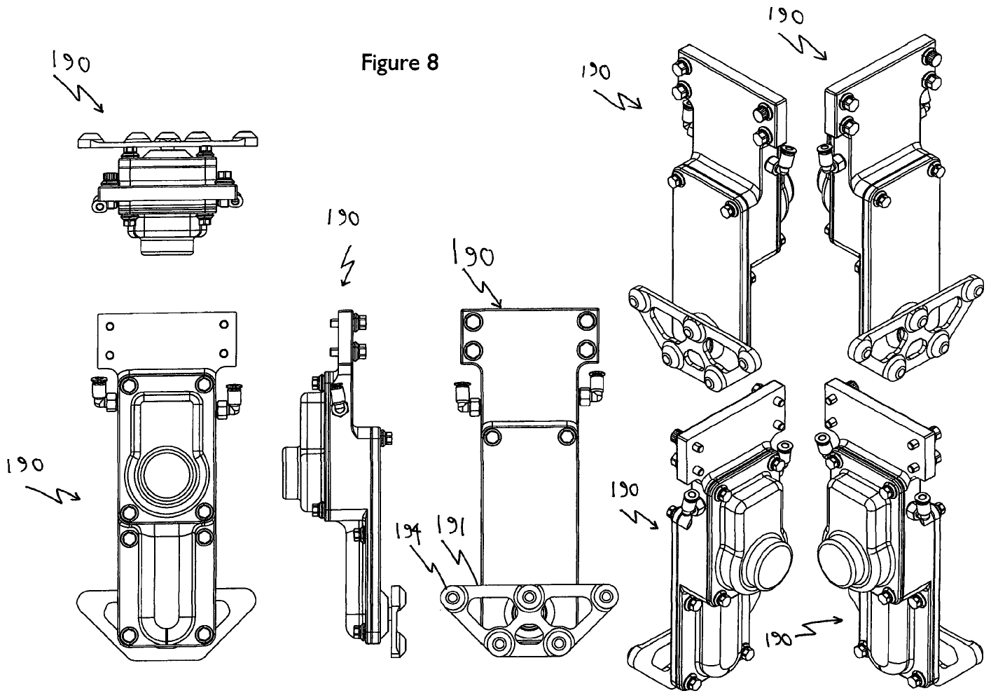

FIG. 8 shows one of the arms 190.

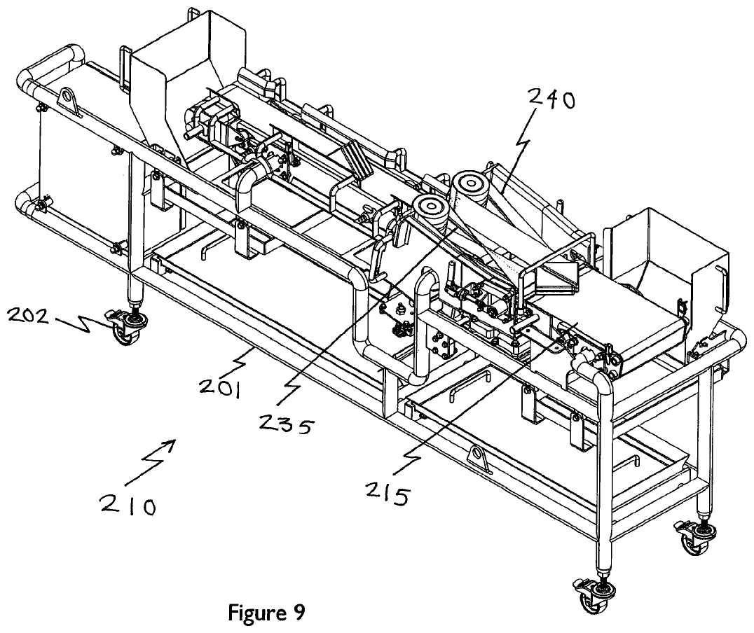

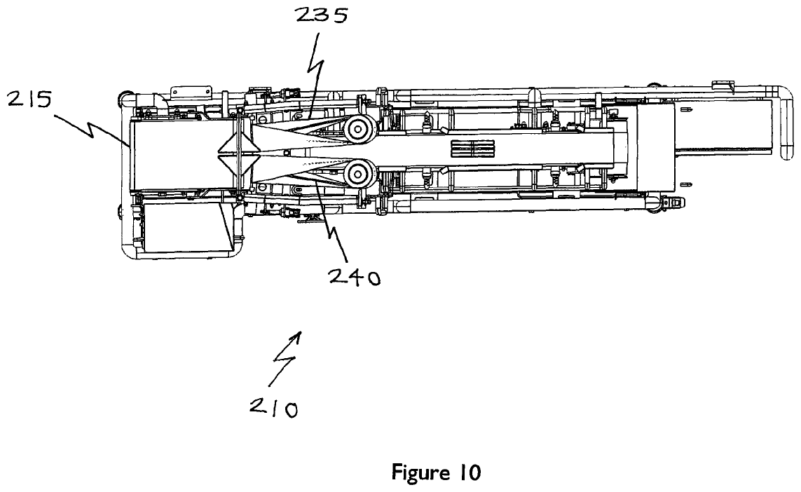

FIGS. 9 and 10 show a food item assembly apparatus 210. A main frame 201 is supported on wheels 202 so that the apparatus is movable.

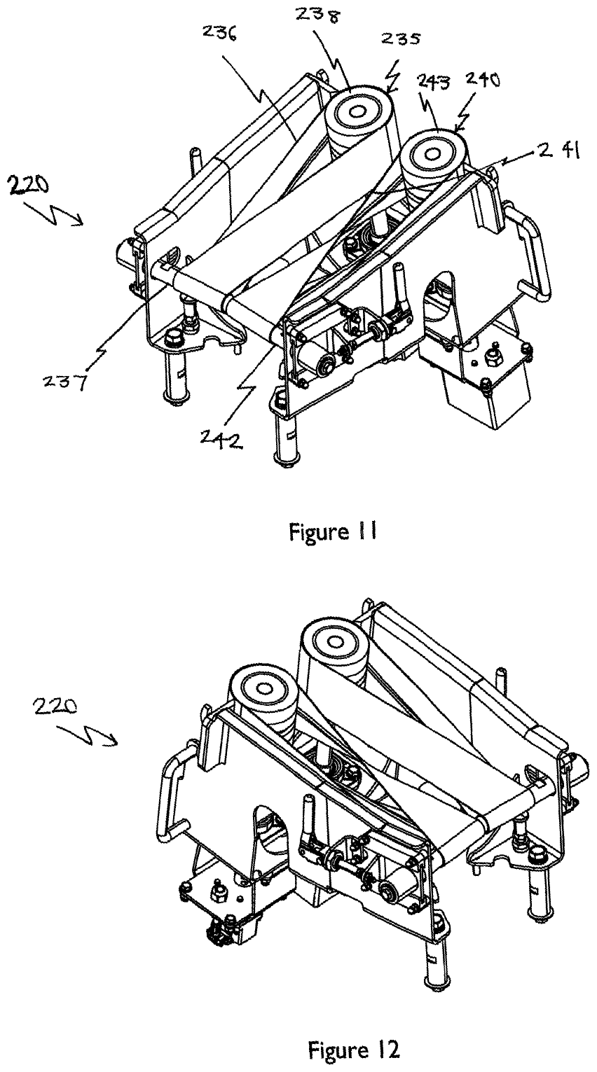

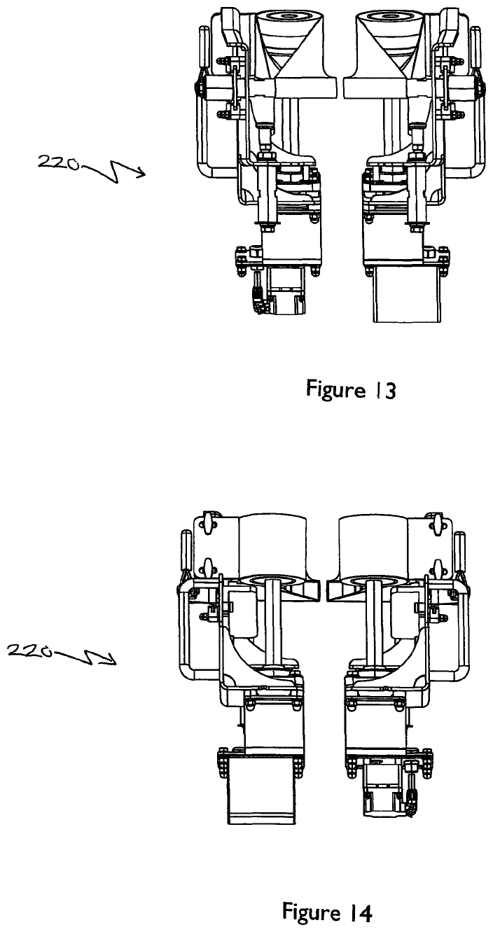

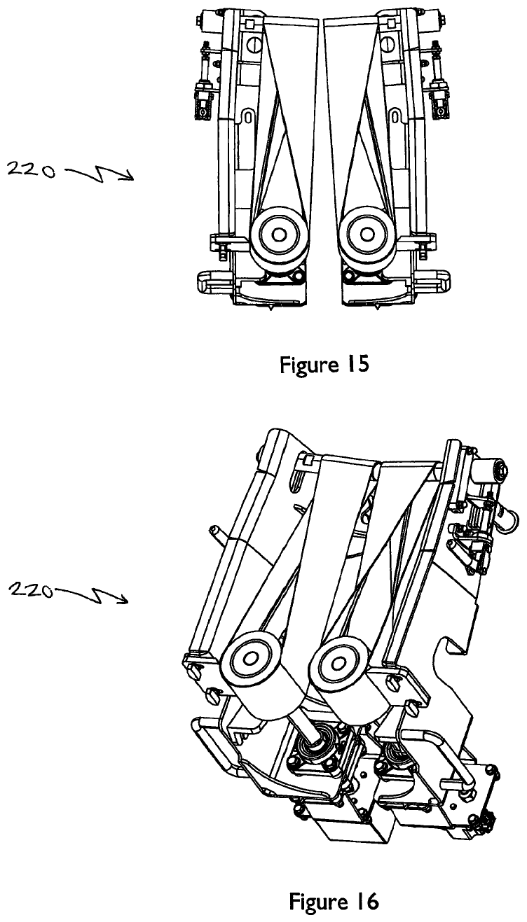

FIGS. 11 to 16 show a manipulation station/orientation conveyor 220 forming part of the machine 210.

The conveyor 220 comprises a pair of opposed, mutually spaced conveyors 235, 240 each comprise an endless belt 236, 241 which is secured at one end (the inlet end) by a generally “horizontal” roller 237, 242 and at the other end by a generally “vertical” roller 238, 243. In this embodiment the vertical rollers are directly driven and the horizontal rollers are driven to rotate by rotation of the belt.

The vertical and horizontal rollers are oriented at approximately 90 degrees with respect to each other (along the line of movement). This means that the belts 36, 41 twist along their length.

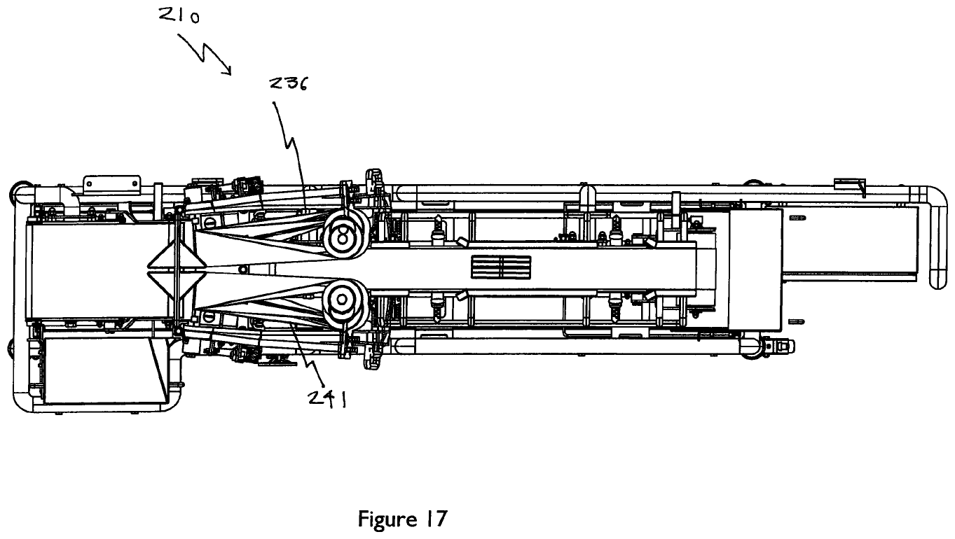

In this embodiment the vertical rollers can be pivoted towards and away from each other, which moves the belts, as illustrated in FIG. 17 (in which two positions of each belt are shown).

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention.

1.-20. (canceled)

21. A sandwich manipulation apparatus comprising manipulation means for moving two sandwich halves from a generally flat, adjacent configuration to an upright, side-by-side configuration, in which the manipulation means comprises a pair of endless belt conveyors.

22. The sandwich manipulation apparatus of claim 21, in which each belt conveyor is secured at one end by a generally horizontal roller and at the other end by a generally vertical roller.

23. The sandwich manipulation apparatus of claim 21, in which the belt conveyors turn through approximately 90 degrees from a sandwich inlet end to a sandwich outlet end.

24. The sandwich manipulation apparatus of claim 23, in which at the sandwich inlet end the belt conveyors are generally horizontal and at the sandwich outlet end the belt conveyors are generally vertical, whereby both belt conveyors twist along their length so as gradually to fold the two sandwich halves together as they pass along therealong.

25. The sandwich manipulation apparatus of claim 21, further comprising a presentation conveyor for presenting the sandwich halves to the manipulation means.

26. The sandwich manipulation apparatus of claim 21, further comprising an outlet conveyor for receiving sandwiches from the manipulation means.

27. The sandwich manipulation apparatus of claim 26, in which the outlet conveyor comprises bays for receiving sandwiches in the upright, side-by-side configuration.

28. The sandwich manipulation apparatus of claim 26, in which the outlet conveyor comprises guide means for preventing delamination of sandwich halves.

29. The sandwich manipulation apparatus of claim 26, further comprising one or more robot pickers for picking sandwiches from the outlet conveyor and transferring them to a packaging container.

30. The sandwich manipulation apparatus of claim 29, in which the robot picker comprises an actuated gripper.

31. The sandwich manipulation apparatus of claim 29, in which the robot picker comprises means for rotating the sandwich with the halves maintained in a side-by-side configuration.

32. The sandwich manipulation apparatus of claim 29, in which the robot picker comprises a pair of spaced grippers, in which either or both grippers have driven rotators for in-line rotation of a gripped sandwich in use.

33. The sandwich manipulation apparatus of claim 29, in which the picker comprising an actuated gripper and means for in-line rotating a sandwich whilst gripped and prior to release.

34. The sandwich manipulation apparatus of claim 21, in which the endless belt conveyors twist along their length.

35. The sandwich manipulation apparatus of claim 32, in which either or both of the grippers can be moved inwards to grip sandwich halves in use.

36. The sandwich manipulation apparatus of claim 29, in which the robot picker comprises two spaced grippers, one gripper is provided with a rotatable disc and the other gripper has a rotating plate, wherein when a sandwich is gripped the rotatable disc is driven to rotate and the plate rotates passively.

37. A method of placing a sandwich into a packaging container, comprising:
providing a pre-prepared sandwich;
pre-cutting the sandwich into two halves;
orientating sandwich halves from a flat configuration to an upstanding configuration; and
placing the juxtaposed sandwich halves into a container.

38. The method of claim 37, in which the sandwich halves are generally triangular.

39. A sandwich making process comprising the steps of:
preparing a sandwich;
cutting the sandwich into two halves;
orientating the sandwich halves so that they are in an upstanding, side-by-side configuration;
using a robot to pick up the sandwich halves together; and
placing the sandwich halves into a container.

40. The process of claim 39, in which the sandwich halves are rotated end-over-end prior to placing into the container.
